(19) United States
(12) Patent Application Publication
(10) Pub. No.: US 2020/0163297 A1
(43) Pub. Date: May 28, 2020

(54) Full Environment Flow Aeroponics System

(71) Applicant: Mason P. Newitt, Orem, UT (US)

(72) Inventor: Mason P. Newitt, Orem, UT (US)

(21) Appl. No.: 16/203,596

(22) Filed: Nov. 28, 2018

(51) Int. Cl. A01G 31/02; F24F 11/00; F24F 3/14

(52) U.S. Cl. CPC A01G 31/02; F24F 2110/10; F24F 3/1405; F24F 11/0008

(57) ABSTRACT

An enclosed controlled environment plant growth chamber based on high pressure aeroponics which features; a system for air temperature control, humidity control, filtering, and exchange in the root and shoot areas; a closed loop design that has no standing water tanks and a low operating water volume; nutrient solution chemistry sensors; nutrient solution dosing; reverse osmosis water filtration; a method of supplying the canopy with light. Whereby all electrical components and sensors are monitored and controlled by a microcontroller.

### CROSS-REFERENCE TO RELATED APPLICATIONS

This application claims the benefit of the U.S. Provisional Patent Application No. 62/591,677 filed Nov. 28, 2017.

### TERMINOLOGY

Root Area: The area surrounding the roots of a plant
Shoot Area: The area surrounding the part of a plant made up of stems, branches, leaves, flowers, vegetation, etc. . . . this is the area of the plant which is typically above ground in open air.
Root Container: The part of the system which provides an enclosed container that surrounds the root area of the plants.
Shoot Enclosure: The part of the system which provides an enclosed container surrounding the shoot area of the plant.
Nutrient Solution: A fluid made up of water, and liquid nutrients for plant cultivation.
Hydroponics: A grow method where the roots of the plant are suspended in water/nutrient mixture.
Aeroponics: A grow method where the roots of the plant are suspended in air and a water/nutrient mixture is sprayed onto them through a mist nozzle.
High Pressure: Greater than 70 PSI
Air Line: A pipe, tube, or hose with the purpose of air passage/flow.
Water Line: A pipe, tube, or hose with the purpose of water passage/flow.

The invention is a system which implements a highly improved variant of the plant cultivation method commonly known as “high pressure aeroponics”. In high pressure aeroponics the roots of a plant are suspended in the air inside of a container, inside this container a mist of nutrient and water mixture is sprayed onto the roots of the plant. The invention solves the most critical issues associated with this growing method, which I discovered when building my own high pressure aeroponics system. Additionally, the invention introduces a variety of advancements to controlled environment agriculture systems beyond the scope of high pressure aeroponics by combining it with regulation of the air in the enclosed plant environment, and sensing and control using a microcontroller.

### Solutions to Traditional High Pressure Aeroponics Issues

In traditional high pressure aeroponics, an non-pressurized reservoir is filled with a mixture of water and nutrients for the pump to draw from. The reservoir typically has liquid level sensor(s) to determine when the tank is full or empty. This non-pressurized reservoir and its liquid level sensor(s) are the root of many problems pertaining to traditional high pressure aeroponics. A reservoir of standing water and nutrient mixture provides a breeding ground for algae which lives on the same nutrient mixture and light as plants. This algae clogs up the pump, filter, and misting heads. Moreover, algae can render most types of liquid level sensors dysfunctional. It jams the moving parts of mechanical float sensors, and causes incorrect readings on conductivity sensors. In a Full Environment Flow Aeroponics System, this tank has been eliminated altogether and all water is kept pressurized. As a result, there is no standing water for algae to grow in. Additionally, water volume requirements are significantly diminished, making it far more efficient to heat or cool the water to a desired temperature. Eliminating this tank also makes for diminished nutrient dilution, meaning that less nutrients need to be added per dose.

In addition to this, when a plant is grown in soil or with hydroponics, the roots are naturally in an environment which is a lower temperature than the shoot area. The lower temperature root area improves transpiration in plants. In traditional high pressure aeroponics, the lack of a medium like soil or water surrounding the roots means there is nothing insulating them to maintain a lower temperature. A Full Environment Flow Aeroponics System is capable of cooling the root area using the mist and air inside of it. Making up for this pitfall of traditional high pressure aeroponics. Likewise, if the Full Environment Flow Aeroponics System is in a space too cold for the roots, or if the specific type of plant requires a warmer root area, the root area can be heated as well.

### Introduction of Shoot Area Enclosure

As aeroponics is simply a method of delivering nutrients and water to the roots of a plant, this section is beyond the scope of high pressure aeroponic improvements. However, the climate conditioner inside of the enclosure also plays a critical role in the introduction of air flow and exchange which is an innovation related to aeroponics, discussed in the next section.

Current high pressure aeroponics solutions must be in a greenhouse or other indoor space where the temperature and humidity are favorable to the plants. But these higher temperature and humidity conditions are not always pleasant for humans, and maintaining these conditions in a large space can be very costly. This restricts those who don't have a greenhouse or a room to dedicate to plant growth from enjoying the benefits of indoor gardening. In a Full Environment Flow Aeroponics System, the controlled climate of a greenhouse is included in the system.

By enclosing the shoot area of the plants, a Full Environment Flow Aeroponics System is then able to regulate the temperature and humidity surrounding the plants in a manner that is isolated from the air surrounding the system. This makes regulation of temperature and humidity much more efficient, as there is less air to regulate. Inside of the shoot area enclosure, the Full Environment Flow Aeroponics System includes an apparatus which can perform the following: 1 Use temperature and humidity sensors to measure the temperature and humidity of the enclosure. 2 Pull air from the enclosure into a sub-chamber. 3 Inside of the sub-chamber that air can be dehumidified, cooled, heated, or humidified. 4 Finally, either returned into the enclosure, exhausted from the system, or blown into the root container (further discussed in the next section).

### Introduction of Shoot and Root Area Air Flow and Exchange

Perhaps the most important principle of aeroponics is that growth can be stimulated by having the roots suspended in air where they have more access to oxygen than they would otherwise have in soil or hydroponics. The roots of plants absorb oxygen inside of the water. However, they also intake oxygen in the air, this is the main reason why overwatering your plants can kill them. We all know that plants produce oxygen, but this oxygen is released through small holes called stomata in the shoot area, not in the root area.

My first hypothesis was what since the roots are depleting the oxygen supply in an enclosed area, over time the oxygen levels in the root area would decrease. To test my hypothesis, I used an oxygen gas sensor and kept the container surrounding the root area closed to monitor oxygen levels. As expected, they slowly but steadily decreased over a couple of days. The larger the plants, the more quickly the oxygen supply is depleted.

My second hypothesis was that since dissolved oxygen enters the water through diffusion (contact), and the oxygen levels in the root area (where the water and air have the most contact) are decreasing, then the dissolved oxygen levels in the water would also fall. To test this, I began with new clean deionized water and used an Oxidation-Reduction Potential (ORP) sensor to measure the ORP values of the water when the root area container stayed closed long enough for oxygen levels to deplete. I then performed the same test, except I opened the root container every 6 hours. As hypothesized, there was more dissolved oxygen present when the container was periodically opened.

My third hypothesis was that, because plants intake carbon dioxide through stomata in the shoot area, they would deplete the carbon dioxide supply in an enclosed area. Similar to the roots in an enclosed area depleting the oxygen supply, I tested this by keeping the shoot area closed for the entire duration of the test, and monitoring carbon dioxide levels inside of the enclosed shoot area. The carbon dioxide levels decreased much more quickly that the oxygen levels inside of the root container. After testing and confirming my hypothesis, I determined that it was necessary to introduce air flow inside of and between both the root container and the shoot enclosure in order to replenish oxygen in the root area, and replenish carbon dioxide in the shoot area. Hence the term “Full Environment Flow”. In a Full Environment Flow Aeroponics System, air can be sucked in from the shoot enclosure where the plants have created oxygen, and blown to the root container to replenish the oxygen supply there, and old air in the root container is exhausted from the system. As this process happens, new air outside of the system (where carbon dioxide levels are higher), is pulled into the shoot enclosure. To simplify: high carbon-dioxide air is pulled into the shoot area where the plants use it and create oxygen through photosynthesis. This high oxygen air is then blown into the root container, and the old air there is pushed out.

Introducing air flow into the root container has benefits beyond replenishing oxygen. It also acts as a way to adjust the temperature of the root area by passing it thought temperature changing components, and to dry the roots more quickly. By drying the roots off more quickly, algae and root disease growth is hampered. It also eliminates the unpleasant smell which tends to accumulate inside of the root container in traditional high pressure aeroponics.

### Introduction of Nutrient Injector and Chemistry Sensors

Whether hydroponic, aeroponic, or other, current grow systems (if they have a nutrient/chemical dosing apparatus) use pumps, typically peristaltic pumps. The peristaltic pump moves nutrient solution from one non-pressurised reservoir, into another non-pressurized reservoir where the water for the plants is kept. Since a Full Environment Flow Aeroponics System does not have any non-pressurised reservoir, using this method would not work. Moreover, since the system holds much less water because of the lack of the non-pressurized tank, it is necessary to have a method of introducing the nutrients into the water that is more accurate than peristaltic pumps. Finally, because all of the water outside of the root container is pressurized, the method of nutrient delivery must also be able to force the nutrient into the pressurized water with more pressure than an inexpensive peristaltic pump can provide. While it is true that there exists peristaltic pumps that are capable of meeting these accuracy and pressure demands, they are extremely expensive. The nutrient injector apparatus in a Full Environment Flow Aeroponics System meets the accuracy and pressure needs at a much lower cost.

Additionally, a built in sensor array for measuring pH, dissolved solids, and content of the nutrient solution is added to automatically monitor these values much more easily and consistently. When this sensor array is used in conjunction with the dosing system described above, the desired nutrient solution traits can be reached, monitored, and maintained automatically.

### BRIEF DESCRIPTION OF FIGURES

FIG. 1—Root Container Assembly. Container where the roots of the plant receive mist, air flow, and temperature regulation.

FIG. 2—Water System Diagram. This is a diagram of all components relating to the water inside of a Full Environment Flow Aeroponics System.

FIG. 3—Nutrient Injector Drawing (Front View). Details component number 25, injects one or more fluids (nutrients) from a syringe into the fluid passing through (water)

FIG. 4—Air Climate Conditioning System Diagram. A diagram of all air flow and regulation components inside of a Full Environment Flow Aeroponics System.

FIG. 5—Flow Chart Of Processes. Flow chart of processes performed by a Full Environment Flow Aeroponics System.

FIG. 6—Expanded View of Blower Fan, Heater, and Air Flow Manifold assembly.

FIG. 7—Simplified Drawing of Full System.

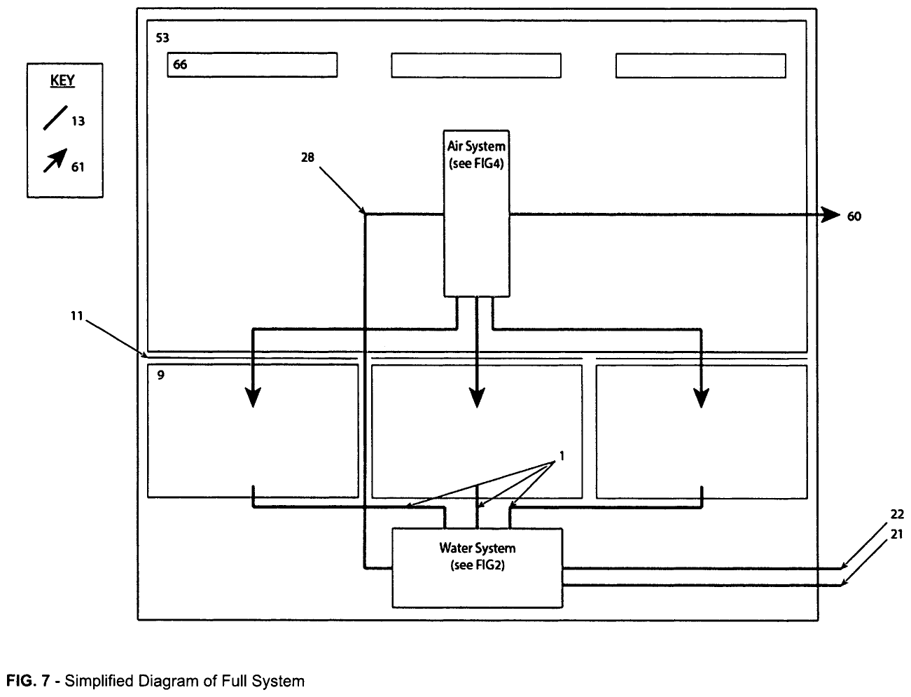

FIG. 8—Image of Shoot Enclosure.

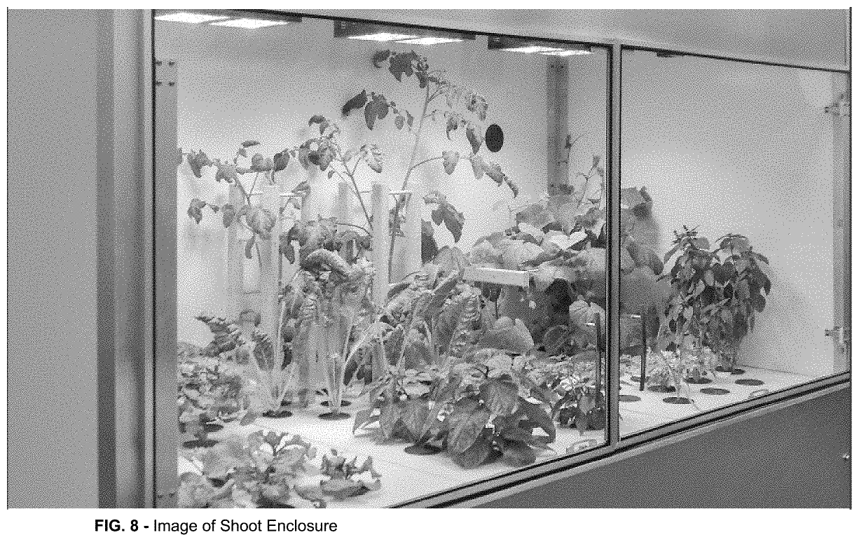

FIG. 9—Drawing of water sensor array example (component 20).

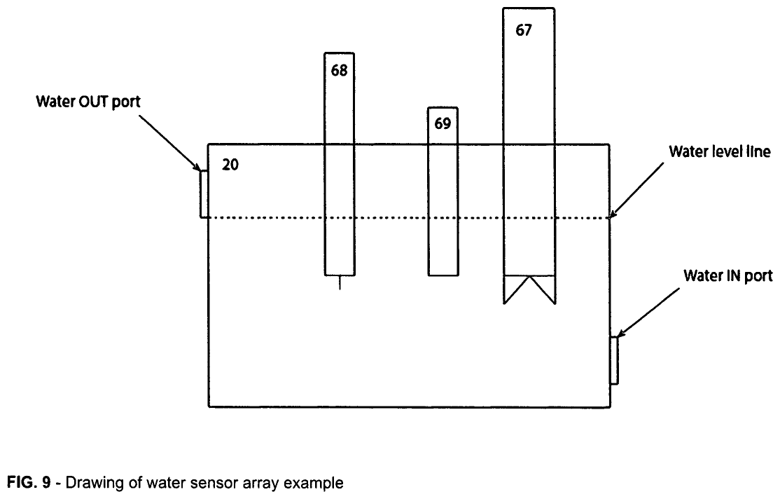

### LIST OF COMPONENT NUMERALS

1—High pressure water line from mist nozzles to mist solenoid valve
2—Root Container Air Exhaust Valve. Allows air to flow in one direction (only out of container), does not allow water to pass through.
3—Anti Drip Mist Nozzles. Create mist when high pressure water passes through.
4—Drain Mouth. Attaches to a water line which connects it back to the high pressure pump so the water can be recycled.
5—Lid Magnetic Seal. A magnetic tape which corresponds in shape and size to the magnetic seal on the root container body. When the lid is on top of the container this makes a water tight seal.
6—Air Inlet Mouth. Attaches to an air line which connects it to the air flow manifold so that air can be exchanged from the shoot enclosure.
7—Waterproof Temperature Sensor
8—Waterproof Temperature Sensor Electrical Cable. Connects the waterproof temperature sensor to the microcontroller
9—Root Container Body. A container with bottom, front, back, left, and right walls. Has holes for the misting water line (1), air exhaust valve (2), drain (4), air inlet mouth (6), and waterproof temperature sensor (7). The top is open with a rim for the magnetic seal to attach.
10—Root Container Body Magnetic Seal. A magnetic tape which corresponds in shape and size to the magnetic seal on the root container lid (5) to create a water tight seal.
11—Root Container Lid. A flat surface with holes for plant holding mechanisms such as net pots or mineral wool to sit. Covers the root container with a magnetic seal.
12—Solenoid Valve. AKA pressure release valve, a device which holds back water pressure, and releases water when an electrical current is passed through.
13—Water Line. A tube, pipe, or hose which allows passage of water from one point to another.
14—Electrical Cable. A wire or circuit trace which conducts electricity for power or sensor readings.
15—Check Valve. A device which only allows flow in one direction (in direction of arrow), and does not allow water flow in the reverse direction.
16—Post Filter. Filters the water which is to be recycled, removes plant matter and other buildup before the water re-enters pressurization.
17—Wet Sensor. Determines when excess water has drained from the root container and needs to be re-pressurized.
18—Water Temperature Regulator. Allows water to flow over a liquid heating element for heating, or a cooling element to cool. Possible cooling thermoelectric cooler, radiator, heat exchanger.
19—Water Filtration System. A reverse osmosis or nanofiltration membrane filter system which all water must pass through before entering the system. Purifies water for plants, reduces chances of mist nozzle clogging.
20—Water Sensor Bank. A grouping of pH, EC, and temperature sensors which tests and record sensor readings on the water that flows through.
21—Water IN Line. Where water entering the Full Environment Flow Aeroponics System is fed through.
22—Water OUT Line. Line where all water exiting the Full Environment Flow Aeroponics System flows through. Waste water from the water filtration system also exits here.
23—Filtered Water Pressure Sensor. Reads the pressure of the filtered water pressure tank to determine if there is new water available.
24—Filtered Water Pressure Tank. A water tank which holds a pressurized reserve of filtered water.
25—Nutrient Injection System. Injects nutrients into the filtered water as it flows through and into the high pressure pump.
26—Pre-Filter. A filter with a screen that blocks out any material larger than the orifice of the anti drip mist nozzle. Prevents pump jamming and mist nozzle clogging.
27—Flow Sensor. Detects if the pump is drawing water as expected.
28—Humidifier Tank Water Line.
29—Self Priming High Pressure Water Pump.
30—Main Pressurized Water Tank. Holds a reserve of water at pressure.
31—Main Water Pressure Sensor. Measures and returns the pressure value of the water inside of the system.
32—Micro-controller. Reads sensor values and distributes electricity to connected devices, using relays. Performs flow chart operations. Is the “nervous system” of the Full Environment Flow Aeroponics System.
33—Stepper Motor Driver. Controls the magnitude and direction of electrical current flow into the motor (40, 39) windings.
34—Syringe Plunger. Fits tightly within the syringe barrel (35), when pressed into the syringe barrel the contents inside are ejected.
35—Syringe Barrel. A hollow cylinder with one open side, and a small opening on the other side. When the plunger (34) is inserted into the open end and pushed into the syringe barrel, the fluids inside are ejected through the small hole.
36—Syringe Barrel Holder. Means of holding the syringe barrel (35) in place.
37—Syringe Needle. A tube open on both sides which attaches to the small opening in the syringe barrel (35) and inserts into the needle valve (38) Provisional Patent Application by Mason Powell Newitt—Page 7 of 22
38—Needle Valve. Allows for the syringe needle (37) to be inserted so that its contents can enter the valve.
39—Alignment Stepper Motor. Provides movement to component 47 in order to align the plunger gantry (51) over the appropriate syringe.
40—Plunger Gantry Stepper Motor. Provides movement to component 46 in order to move the pressure head (52) into and press the syringe plungers (34)
41—Plunger Contact Sensor. A magnetic hall effect sensor which detects if the pressure head (52) has made physical contact with the syringe plunger (34)
42—Pressure Head Contact Sensor. Is used to determine if the pressure head (52) is in the top or bottom position.
43—Plunger Gantry Contact Sensor. Determines if the plunger gantry (51) is in the ‘home’ position, not aligned with any syringe.
44—Pressure Head Body. Holds contact sensors 41 and 42. This is the part that presses the syringe plunger (34) into the syringe barrel (35) in order to inject into the water line.
45—Plunger Gantry Body. Holds all components of the plunger gantry (51).
46—Pressure Head Positioning Component. Means of moving the pressure head (52) in the direction that the syringe plunger (34) inserts into the syringe barrel (35). Best choice for this component is a threaded rod and nut.
47—Plunger Gantry Positioning Component. Means of aligning the plunger gantry (51) with the appropriate syringe. Best choice for this component is a threaded rod and nut.
48—Syringe Plunger Magnet. Provides a detection point so that the plunger contact sensor (41) can sense if and when the pressure head (52) is in physical contact with the syringe plunger (34).
49—Plunger Gantry Magnet. Serves as a detection point for the pressure head contact sensor (42) Also serves as a detection point for the plunger gantry contact sensor (43).
50—Empty Syringe Magnet. Serves as a detection point for the pressure head contact sensor (42) to sense if the pressure head (42) is in the bottom position and the syringe is empty.
51—Plunger Gantry. Means of aligning with the appropriate syringe and then pressing its plunger into its barrel.
52—Pressure Head. Senses when it has physical contact with a syringe plunger (34), has means of pushing the syringe plunger of the syringe which the plunger gantry (51) is aligned with.
53—Shoot Enclosure. The air tight enclosure surrounding the shoot area of the plants.
54—Refrigerant Condenser Unit. Condenses a refrigerant and feeds to the refrigerant evaporator (55).
55—Refrigerant Evaporator. Takes a condensed refrigerant from the refrigerant condenser (54), acts as the cooler and dehumidifier.
56—Blower Fan. A fan which pulls air from the shoot enclosure (53)
57—Heater. Heats the air as it blows through this component, if the heater is powered.
58—Air Flow Manifold. Uses one or more motors to direct air flow to one of the following places: back into the shoot enclosure (53), exhausted from the system (60), or into a root container (9)
59—Humidifier. Composed of a water tank with a self regulating valve such as a float valve, and an ultrasonic humidifier. Has an opening for air coming from the air flow manifold (58) and another opening leading back into the shoot enclosure (53)
60—Air Exhaust Points. Openings where air exits the system.
61—Air Line. A tube, pipe, or hose whose purpose is to direct air flow.
62—Fan to Heater Mounting Plate
63—Air Flow Manifold Selector Plate. Rotates to align with the appropriate opening in the Air Flow Manifold Connector Plate (64).
64—Air Flow Manifold Connector Plate. Connects to air lines leading to: humidifier, root containers, and exhaust.
65—Air Flow Manifold Motor. Motor mounted to the connector plate (64), whose shaft is connected to the selector plate (63) so that it may rotate.
66—Grow Lights. Typically LED grow lights with the purpose of giving photosynthetic active radiation to the plants.
67—pH Probe. Measures the pH of a liquid.
68—EC Meter. Measures the electrical conductivity of a liquid.
69—Water temperature sensor. Measures the temperature of water.
70—Enclosure Temperature and Humidity Sensor. Measures temperature and humidity of the shoot enclosure.

How the Components Connect:

Notes:

Component numerals listed as (“C”:#)

Example: Component 17=(C:17)

If a connected component is not shown in the currently discussed figure, the figure it is shown in is listed.

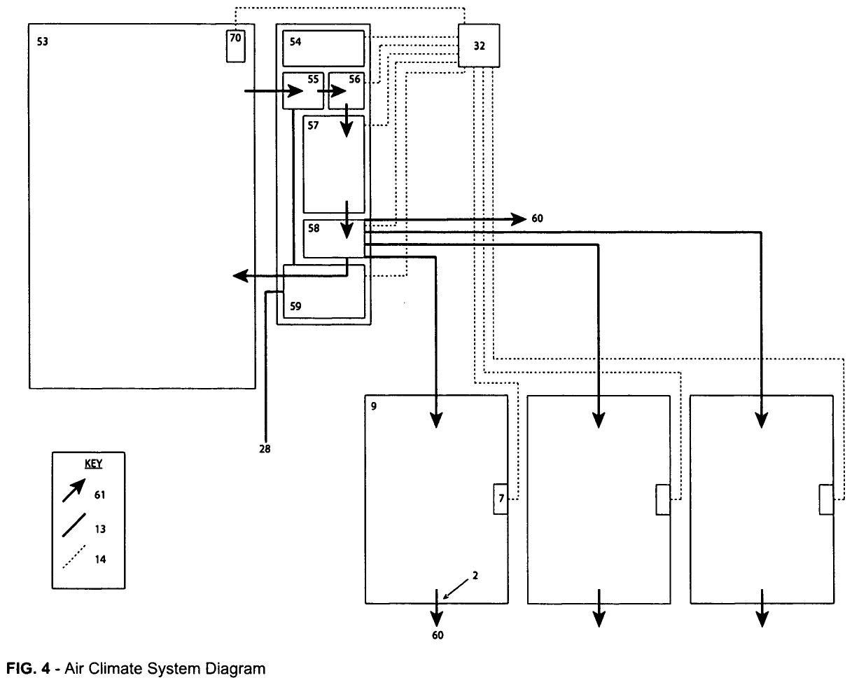

Example: (C:17 shown in FIG. 4)

Drawings depict a system with 3 root containers, in reality a system could include as little as 1 or far greater than 3. For this reason individual root containers and their associated components are not individually numbered as they are simply a repetition of the numbered root container and its components.

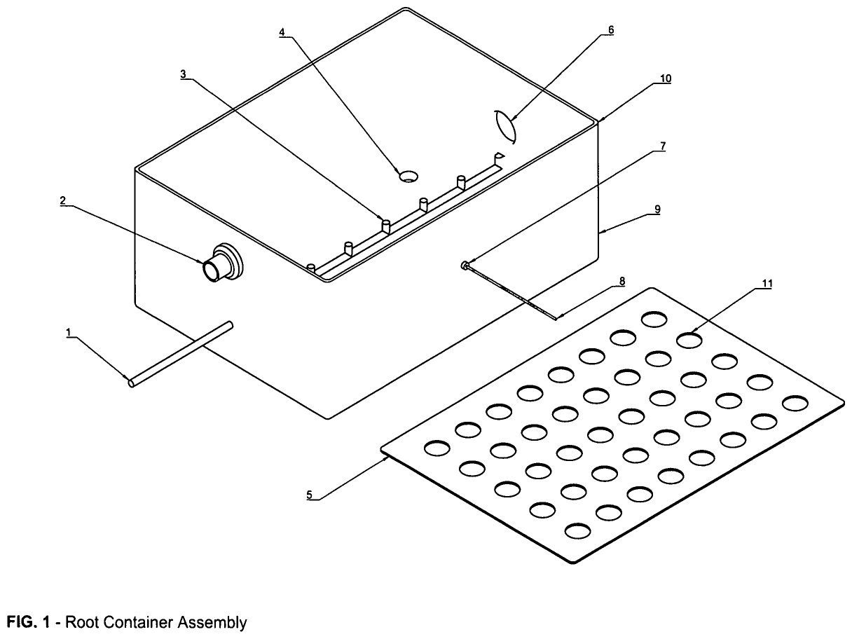

FIG. 1 Based Connections

FIG. 1 is an image of the root container assembly. This is the area of a Full Environment Flow Aeroponics System where the roots of the plant exist, where mist can be sprayed on them, and inside of which the air inside can be exchanged and exhausted from the system.

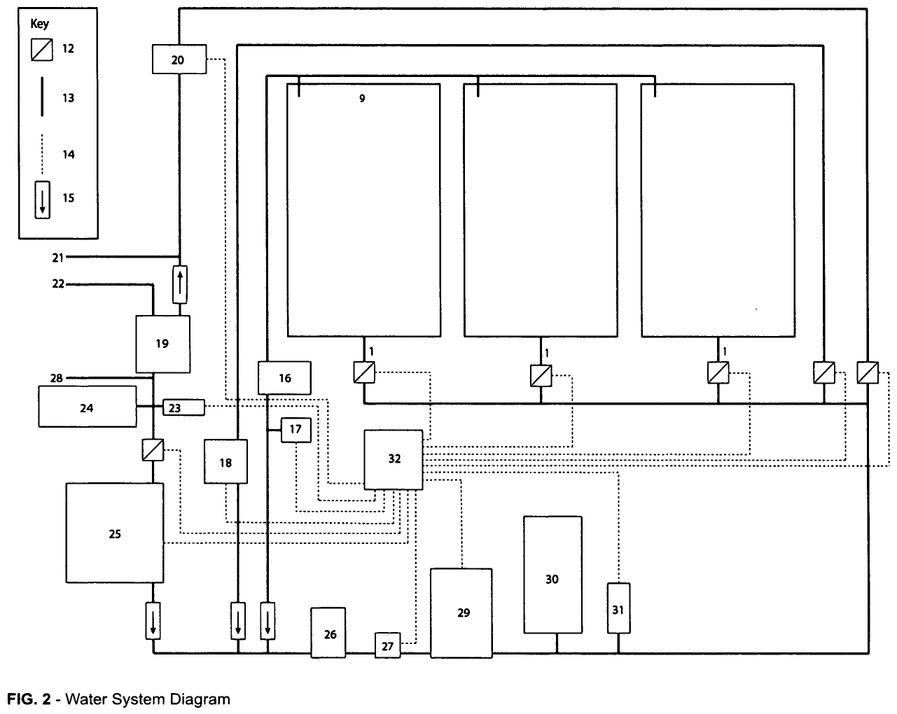

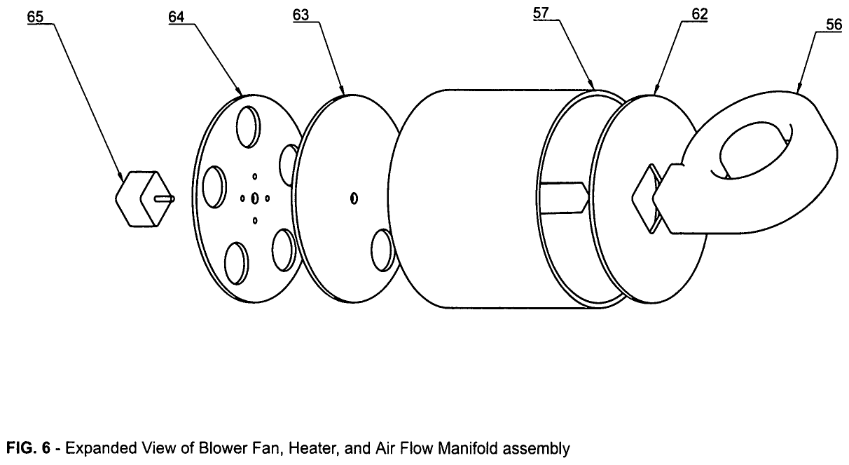

It is made up of an open top container, the root container body (C:9) which has openings for the air inlet mouth (C:6), drain mouth (C:4), and root container exhaust valve (C:2). Additionally, it has an opening for the waterproof temperature sensor (C:7) which the sensor is mounted to. Finally, it has an opening which houses the high pressure water line from mist nozzles to solenoid valve (C:1).
(C:1)—High Pressure Water Line From Mist Nozzles to Solenoid Valve. A water line connecting the misting nozzles (C:3) to a solenoid valve (C:12) the associated solenoid valve can be determined in FIG. 2.
(C:2)—Root Container Exhaust Valve. Creates an air exhaust point (C:60 shown in FIG. 4).
(C:3)—Anti Drip Mist Nozzles. Connected to (C:1).
(C:4)—Drain Mouth. Connects by water line to the post filter (C:16 Shown in FIG. 2).
(C:5)—Lid Magnetic Seal. Is permanently attached to the root container lid (C:11) with the magnetic side facing down.
(C:6)—Air Inlet Mouth. Connects by air line to an opening the air flow manifold connector plate (C:63 shown in FIG. 6).
(C:7)—Waterproof Temperature Sensor. Connects to the microcontroller (C:32 shown in FIG. 4) by electrical cable.
(C:8)—Waterproof Temperature Sensor Electrical Cable. Connected to the waterproof temperature sensor (C:7) and the microcontroller (C:32 shown in FIG. 4).
(C:9)—Root Container Body. See description in second paragraph of FIG. 1 connections section for details.
(C:10)—Root Container Magnetic Seal. Is permanently attached to the top of the root container body (C:9) with the magnetic side facing up.
(C:11)—Root Container Lid. When sitting on top of the root container body, creates a watertight magnetic seal between the two magnetic seals (C:5) and (C:10).

FIG. 2 Based Connections

FIG. 2 is a diagram of all water related components and connections between water related components in a Full Environment Flow Aeroponics System. Simple and highly repeated components are numbered in the KEY of the figure, these include (C:12)-(C-15). Though all water system components are technically connected indirectly, they have been separated into the following sections for purpose based simplification.

Pressurized Components

These are the components which pertain to bringing the water to the desired pressure, and then releasing it using solenoid valves, to the mist nozzles (C:3 shown in FIG. 1), the drain and sensing components, or the water temperature components.

This section begins with the pre-filter (C:26), which connects to the flow sensor (C:27). The flow sensor then connects to the self priming high pressure water pump (C:29). The high pressure water pump then connects to the main pressurized water tank (C:30) and the main water pressure sensor (C:31), and then finally to an array of solenoid valves of size 2+# of root containers. One solenoid leads to the water.

temperature components, another leads to the drain and sensing components, and the remainder connect are connected to repetitions of the high pressure water line (C:1), detailed further in the FIG. 1 connections section. The connection to these solenoid valves concludes this section. All connections made in this paragraph are by water line.

The flow sensor (C:27), high pressure pump (C:29), and main water pressure sensor (C:31), are individually connected to the microcontroller by electrical cable(C:32).

New Water Components

These are the components which provide the system with means of introducing new water and nutrients to the system. Water and nutrients in this section are pressurized, but at a lower pressure than the pressurized components section, the exact pressure is dependant on the pressure of the water coming from the water IN line (C:22).

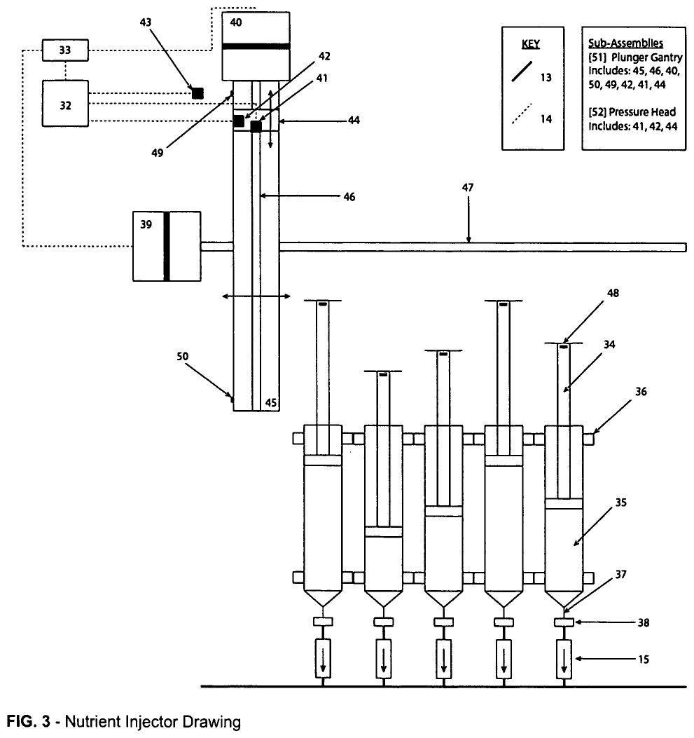

This section begins with the water IN line (C:22) which connects to the water filtration system (C:19). Because nano and reverse osmosis filtration systems create wastewater, the wastewater line is connected to a check valve and then to the water OUT line (C:21). The filtration system is connected to the filtered water pressure tank (C:24), the filtered water pressure sensor (C:23), and the associated solenoid valve directly below, by water line. This water line also connects to the humidifier (C:59 shown in FIG. 4) by the humidifier water tank line (C:28). The associated solenoid valve and the filtered water pressure sensor are connected to the microcontroller (C:32) by electrical cable. The associated solenoid valve is then connected to the nutrient injector (C:25), the details of which can be seen in FIG. 3. The nutrient injector is then connected to a check valve, and finally pre-filter (C:26), this connection being the end of the new water components section.

Return Water Components

These are the components which pertain to the excess return/drain water coming from the root containers, leading back to the pressurized components. The section begins with the drain mouth (C:4 shown in FIG. 1), which connects to the post filter (C:16) by water line. This water line connects to the wet sensor (C:17) and a check valve directly below, finally connecting to the pre-filter (C:26), concluding this section. The wet sensor is connected to the microcontroller (C:32) by an electrical cable.

Water Temperature Components

The purpose of these components is to create a “flow loop” so that the water in the main pressurized water tank (C:30) can be repeatedly ran through the water temperature regulator (C:18) to be heated or cooled, then back to the high pressure pump (C:29), and return to the main pressurized water tank.

This section is simply composed of the water temperature regulator (C:18) which is connected by water line to a solenoid valve that is connected to the pressurized components, also discussed in pressurised components section. The water temperature regulator is then connected by water line to a check valve which finally leads back to the pre-filter (C:26).

The cooling and heating elements inside of the water temperature regulator are separately connected to the microcontroller (C:32) by electrical cable.

Drain and Sensing Components

This section serves to drain water from the system, and run pH, EC, and temperature tests on the water. A solenoid valve is connected to the pressurized components (see pressurized components section) this solenoid valve is connected by water line to the water sensor bank (C:20).

The sensors inside of the water sensor bank, pH probe (C:67 shown in FIG. 10), EC meter (C:68 shown in FIG. 10), and water temperature sensor (C:69 shown in FIG. 10), are each individually connected to the microcontroller (C:32) by electrical cable

FIG. 3 Based Connections

This figure details the nutrient injector (C:25). It's purpose is to inject nutrients into a water line using syringes with high precision. Inside of this drawing are two subassemblies which are notated in the drawing and described in the component numerals.

Sub-Assembly: Plunger Gantry (C:51)

The purpose of this assembly is to be aligned over the correct syringe plunger (C:34), and then to press the pressure head (C:52) into the syringe plunger, which in turn presses the plunger deeper into the syringe barrel (C:35), injecting its contents into the water line. This assembly begins with the plunger gantry body (C:45), which houses all components of the plunger gantry. The plunger gantry body is connected to the plunger gantry positioning component (C:47) with a threaded rod and nut, the nut being stationarily attached to the gantry body, and the threaded rod being the gantry positioning component. When the threaded rod rotates, the movement of its threads between the threads of the nut translates into linear movement and allows the plunger gantry to move so that it may align over the appropriate syringe body, in the drawing, this is horizontal (as notated by the double ended arrow). The shaft of the alignment stepper motor (C:39) is attached to the threaded rod (C:47), allowing the alignment stepper motor to move the plunger gantry.

The plunger gantry stepper motor (C:40) is attached to the gantry body. The shaft of the gantry stepper motor is attached to another threaded rod (pressure head positioning component (C:46)) so that the threaded rod may rotate. In a manner identical to the one described in the paragraph above, there is a nut on the pressure head (C:52) which is threaded onto the positioning component (C:46), allowing the gantry stepper motor to effectively move the pressure head in the direction that the syringe plunger (C:34) inserts into the syringe barrel (C:35), in the drawing, this is vertical (as notated by the double ended arrow).

(C:49) & (C:50) are magnets which serve as sensing points for the pressure head contact sensor (C:42). (C:49) also serves as a sensing point for the plunger gantry contact sensor (C:43). (C:49) & (C:50) are attached to the gantry body so that when the pressure head (C:52) is at the bottom of the gantry body, (C:42) is triggered by (C:50), and when the pressure head is at the top of the gantry body, it is triggered by (C:49).

Sub-Assembly: Pressure Head (C:52)

The pressure head is made up of the pressure head body (C:44) which is large enough to press on the syringe plunger (C:34), it is threaded to the threaded rod (C:46). It has a hall effect sensor (plunger contact sensor (C:41)) attached facing the syringe plunger magnets (C:48) and aligned with them on the non-variable axis. It has another hall effect sensor (C:42) which is connected facing the plunger gantry magnet (C:49) and the empty syringe magnet (C:50).

The plunger gantry stepper motor (C:40) and the alignment stepper motor (C:39) are connected to the stepper motor driver (C:33) by an electrical cable. The stepper motor driver is connected to the microcontroller (C:32) by an electrical cable.

Syringe Section

This is the section in the lower portion of the drawing, containing the syringe and water line components. This section is simply a repeated assembly which can be as wide as the plunger gantry positioning component (C:47) is long. The drawing shows a nutrient injector with 5 syringes.

The connections in this assembly are as follows: The syringe barrel (C:35) is stationarily attached to the syringe barrel holder (C:36). The syringe plunger (C:34) is inside of the syringe barrel, in the way that a typical syringe would be. At the end of the syringe plunger which is NOT inside of the barrel, is the syringe plunger magnet (C:48). At the nose of the syringe, the syringe needle (C:37) is attached. The syringe needle can be inserted into the needle valve (C:38) which is connected by water line to a check valve (C:15) which leads to the water line passing through the nutrient injector.

FIG. 4 Based Connections

FIG. 4 shows the air control components of a Full Environment Flow Aeroponics System. These are the elements which humidify, heat, dehumidify, cool, and direct air flow.

Connections are as follows: The refrigerant condenser unit (C:54) is connected to the refrigerant evaporator (C:55) by a refrigerant line leading to the evaporator, and another refrigerant line leading from the evaporator. The condenser unit is connected by electrical cable to the microcontroller (C:32). The refrigerant evaporator is connected by air line to the shoot enclosure (C:53), and again by air line to the blower fan (C:56). The blower fan is then connected to the microcontroller by electrical cable, and to the heater (C:57) by air line. The heater is connected to the microcontroller by electrical cable, and to the air flow manifold (C:58) by air line. The air flow manifold is connected to the humidifier (C:59), an exhaust point (C:60), and each root container (C:9) by air line. More details about the air flow manifold in FIG. 6 based connections. The humidifier (C:59) is then connected by air line into the shoot enclosure (C:53), the humidifier is connected to the microcontroller by electrical cable. Finally, the enclosure temperature and humidity sensor (C:70) is connected to the microcontroller by electrical cable.

FIG. 6 Based Connections

FIG. 6 is an image which shows an expanded view of blower fan, heater, and air flow manifold assembly. The exhaust opening of blower fan (C:56) is attached directly to the fan to heater mounting plate (C:62). The fan to heater mounting plate is then attached directly to the top of the heater (C:57). The air flow manifold connector plate (C:64) is attached directly to the base of the heater, with the air flow manifold selector plate (C:63) inside of the base of the heater, but not attached to the connector plate or heater. The air flow manifold motor (C:65) is stationarily connected to the selector plate with the shaft going through the center hole and into the heater. The shaft of the manifold motor is connected to the selector plate so that the selector plate may rotate. The direct connections in this section serve as air lines in the FIG. 4 Based Connections section.

Finally, the grow lights (C:66) are connected to the ceiling of the enclosure, so that they are facing down on the root container lids (C:11 shown in FIG. 1). The grow lights are connected to the microcontroller (C:32) by electrical cable.

Operation

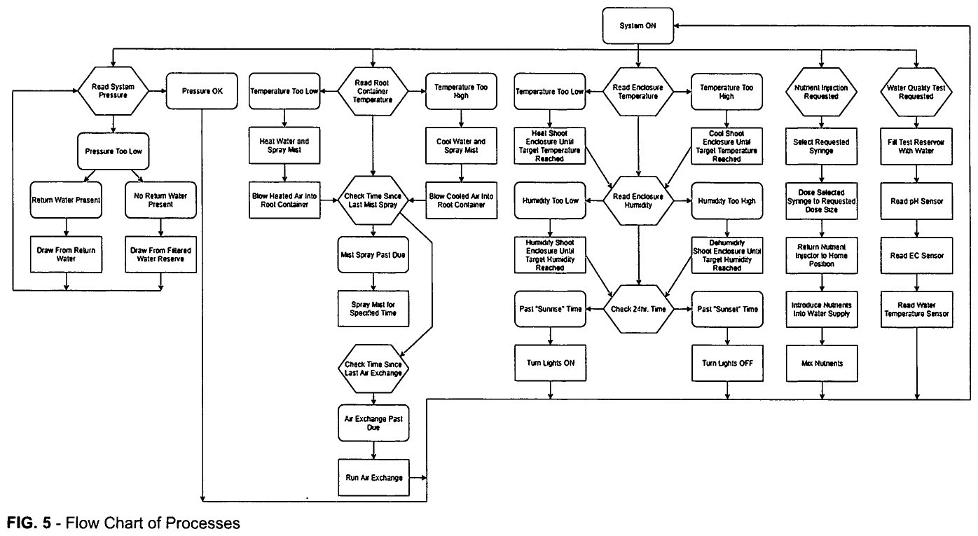

This section greatly details the operations described in the FIG. 5 flowchart, explaining how the Full Environment Flow Aeroponics System performs each operation in the flowchart on a step-by-step level. This section is separated into 5 subsections. Pressurization operations, root operations, shoot operations, nutrient operations, and testing operations. These subsections correspond with the 5 sections of the flow chart from left to right, respectively. When reading the flowchart, diamond boxes signify sensor readings or other inputs to the microcontroller, rounded corner boxes signify ‘if’ conditions, sharp corner boxes signify tasks. Properties that are ‘set by user’ can be sent into the microcontroller from a computer, or additional hardware, these are not included in this invention.

Pressurization Operations

Read System Pressure—The microcontroller (C:32) gets a reading from the main water pressure sensor (C:31).

Pressure OK—Microcontroller determines if pressure reading is within acceptable range set by user, no further pressurization operations needed.

Pressure Too Low—Microcontroller determines that the pressure reading is below acceptable range set by user.

Return Water Present—Microcontroller gets a reading from the wet sensor (C:17) and determines that there is return water present.

Draw From Return Water—The microcontroller feeds power to the high pressure water pump (C:29) until pressure is within acceptable range, or return water is no longer present, in which case pressurization operations are repeated.

No Return Water Present—Microcontroller gets a reading from the wet sensor (C:17) and determines that there is no return water present.

Draw From Filtered Water Reserve—The microcontroller feeds power to the solenoid valve connected to the water filtration system (C:19) which provides filtered water to the high pressure pump. The microcontroller then feeds power to the high pressure water pump until pressure is within acceptable range, in which case the microcontroller cuts power to the pump and solenoid valve.

Root Operations

Read Root Container Temperature—The microcontroller gets a reading from the waterproof temperature sensor (C:7).

Temperature Too Low—Microcontroller compares temperature reading to target temperature and determines that the temperature reading is too low.

Heat Water and Spray Mist—The water heating element inside of the water temperature regulator (C:18), its associated solenoid valve, and the high pressure water pump (C:29) are powered by the microcontroller. The solenoid valve connected to the root container by high pressure water line (C:1) is powered which releases warm water into the root container.

Blow Heated Air Into the Root Container—the microcontroller rotates the air flow manifold selector plate (C:63) so that its hole is aligned with the hole in the connector plate (C:64) connected to the root container by air line. The microcontroller feeds power to the heater (C:57), and the blower fan (C:56), blowing warm air into the root container

Temperature Too High—Microcontroller compares temperature reading to target temperature and determines that the temperature reading is too high.

Cool Water and Spray Mist—The water cooling element inside of the water temperature regulator, its associated solenoid valve, and the high pressure water pump are powered by the microcontroller. The solenoid valve connected to the root container by high pressure water line is powered which releases cool water into the root container.

Blow Cooled Air Into the Root Container—the microcontroller rotates the air flow manifold selector plate so that its hole is aligned with the hole in the connector plate connected to the root container by air line. The microcontroller feeds power to the refrigerant condenser unit (C:54), and the blower fan, blowing cool air into the root container.

Check Time Since Last Mist Spray—Microcontroller checks time and compares to the last time the mist was sprayed.

Mist Spray Past Due—Time since mist was last sprayed is longer than the time set by user.

Spray Mist For Specified Time—Microcontroller powers the solenoid associated with the root container for the amount of time set by the user.

Check Time Since Last Mist Spray—Microcontroller checks time and compares to the last time the air in the root container was exchanged.

Air Exchange Past Due—Time since last air exchange is longer than the time set by user.

Run Air Exchange—the microcontroller rotates the air flow manifold selector plate so that its hole is aligned with the hole in the connector plate connected to the root container by air line. The microcontroller feeds power to the blower fan, flushing out the air in the root container.

Enclosure Operations

Read Enclosure Temperature—Microcontroller gets a temperature reading from the Enclosure Temp and Humidity Sensor (C:70).

Temperature Too Low—Microcontroller compares temperature reading to target temperature and determines that the temperature reading is too low.

Heat Shoot Enclosure—the microcontroller rotates the air flow manifold selector plate (C:63) so that its hole is aligned with the hole in the connector plate (C:64) connected to the humidifier (C:59) by air line. The microcontroller feeds power to the heater (C:57), and the blower fan (C:56), blowing warm air into the shoot enclosure (C:53).

Temperature Too High—Microcontroller compares temperature reading to target temperature and determines that the temperature reading is too high.

Cool Shoot Enclosure—the microcontroller rotates the air flow manifold selector plate (C:63) so that its hole is aligned with the hole in the connector plate (C:64) connected to the humidifier (C:59) by air line. The microcontroller feeds power to the refrigerant condenser unit (C:54), and the blower fan (C:56), blowing cool air into the shoot enclosure.

Read Enclosure Humidity—Microcontroller gets a humidity reading from the Enclosure Temp and Humidity Sensor (C:70).

Humidity Too Low—Microcontroller compares humidity reading to target temperature and determines that the humidity reading is too low.

Humidify Shoot Enclosure—the microcontroller rotates the air flow manifold selector plate (C:63) so that its hole is aligned with the hole in the connector plate (C:64) connected to the humidifier (C:59) by air line. The microcontroller feeds power to the humidifier (C:59), and the blower fan (C:56), blowing heated air into the shoot enclosure.

Humidity Too High—Microcontroller compares humidity reading to target temperature and determines that the humidity reading is too high.

Dehumidify Shoot Enclosure—the microcontroller rotates the air flow manifold selector plate (C:63) so that its hole is aligned with the hole in the connector plate (C:64) connected to the humidifier (C:59) by air line. The microcontroller feeds power to the refrigerant condenser (C:54), and the blower fan (C:56), blowing cool air into the shoot enclosure. Because air condenses at lower temperatures, condensation builds up on the refrigerant evaporator (C:55), and drips into the humidifier through the water line connecting to the humidifier (C:59) shown in FIG. 4. Because this can cause an undesired decrease in temperature, the heater may need to be powered after the cooling cycle to counteract the cooling.

Check 24 hr. Time—Microcontroller reads the 24 hour time from clock.

Past “Sunrise” time—Microcontroller compares current time to the time when lights are supposed to be turned on, determines it is equal to or past this time.

Microcontroller feeds power to grow lights (C:66), keeps powered.

Past “Sunset” time—Microcontroller compares current time to the time when lights are supposed to be turned off, determines it is equal to or past this time.

Microcontroller cuts power to grow lights (C:66)

Nutrient Operations

Nutrient Injection Requested—Microcontroller receives a request to perform a nutrient dose on a specified syringe to a specified amount.

Select Requested Syringe—The alignment stepper motor (C:39) performs a preprogrammed number of rotations in the direction which brings the plunger gantry closer to the specified syringe.

Dose Selected Nutrient—The plunger gantry stepper motor (C:40) performs a preprogrammed number of rotations in the direction which brings the pressure head towards the syringe plunger (C:34). Rotates until the plunger contact sensor (C:41) is triggered by the plunger magnet (C:48). The plunger gantry stepper motor (C:40) performs a number of rotations in the direction which presses the pressure head deeper into the syringe barrel (C:35). The exact number of rotations being dependant on the specified nutrient amount. This forces the nutrient into the water line.

Return Nutrient Injector to the Home Position—The plunger gantry stepper motor (C:40) rotates in the direction which brings the pressure head away from the syringe plunger (C:34) until the pressure head contact sensor (C:42) is triggered by the plunger gantry magnet when the pressure head is as far from the syringe assembly as possible. The alignment stepper motor (C:39) rotates in the direction which brings the plunger gantry towards the plunger gantry contact sensor. Rotates until the plunger gantry contact sensor is triggered by the plunger gantry magnet.

Introduce Nutrients Into Water Supply—The solenoid connected by water line to the Water Filtration System (C:19) is powered by the microcontroller. This forces water into the nutrient injector (C:25) and creates a water source for the high pressure water pump (C:29). The high pressure water pump is also powered by the microcontroller for a few seconds for the nutrient to be flushed into the high pressure water supply. Power is then cut to the solenoid, the pump remains powered for nutrient mixing.

Mix Nutrients—The solenoid associated with the water temperature regulator (C:18) is powered by the microcontroller, opening the flow loop. Since the pump is left on from nutrient introduction, the flow loop mixes the nutrients. Power is then cut to both the solenoid and the high pressure water pump.

Testing Operations

Water Quality Test Requested—The microcontroller processes a request to test the system water.

Fill Test Reservoir With Water—The solenoid associated with the water sensor bank is powered for a few seconds to fill the chamber and then shut off.

Read pH/EC/Temperature Sensor—The microcontroller gets a reading from the following sensors and then stores the reading. pH Probe (C:68), EC Meter (C:68), and Water Temperature Sensor (C:69).

Additional Operations

Air Exhaust From Shoot Enclosure—The microcontroller rotates the air flow manifold selector plate (C:63) so that its hole is aligned with the hole in the connector plate (C:64) connected to the air line which creates an air exhaust point (C:60). The microcontroller feeds power to the blower fan (C:56), exhausting air from the shoot enclosure (C:53).

Water Drain—The microcontroller powers the solenoid associated with the water sensor bank (C:20) so that water is ejected into the water OUT line (C:21), and ultimately out of the system.

### Alternative Embodiments

Individual plunger gantry assemblies over each syringe assembly instead of a single plunger gantry which moves to align over multiple syringe assemblies. With this system another check valve similar to (C:15) could be used to allow flow back into the syringe when the motor reverses direction, ultimately allowing the syringe to refill itself from a larger tank.

Water Heater and Cooler elements are on water tank instead of inside of the water temperature regulator. This means no flow loop is needed to change water temperature, however a flow loop is still needed for nutrient mixing.

The intake fan shown (C:56) could be replaced by multiple intake fans at different locations such as inside the enclosure, inside the root container, or drawing from the ambient air, to get much more utility from the temperature and humidity control tools in the climate controller.

Alternative Uses:

Grow algae with small container lid modification where a screen would be present in the place where the holes in the root container lid are.

Nutrient injector has MANY applications which call for precise and or pressurized fluid feeding into another fluid.

Pressurization techniques could also be implemented in a hydroponics system to reduce problems caused by standing water tanks, by keeping the water pressurized.

Climate conditioning system could be used to monitor and regulate the temperature and humidity of an enclosure for animals.

1. An improved variant of a high pressure aeroponics nutrient delivery system for plant cultivation, the improvement comprising:
1. 1. A high pressure aeroponics system in accordance with claim 1, utilizing closed loop fluid system functioning by releasing a pressurized nutrient solution into small orifices to expel mist onto the roots of a plant, excess nutrient solution is then sensed and immediately returned to the pressurized system by the pump instead of being stored in the problematic standing water reservoir used in traditional hydroponics and aeroponics systems.
1. 2. A high pressure aeroponics system in accordance with claim 1, further comprising a reverse osmosis water filtration system which feeds uncontaminated water into the aforementioned closed loop when more water is needed to reach pressure.
1. 3. A high pressure aeroponics system in accordance with claim 1, further comprising an apparatus for precisely pumping pure nutrients or other concentrated fluids into the aforementioned closed loop.
1. 4. A high pressure aeroponics system in accordance with claim 1, utilizing a mechanism for blocking nutrient solution from reaching the aforementioned orifices if the pressure is not high enough to generate mist.
1. 5. A high pressure aeroponics system in accordance with claim 1, further comprising a pressure release valve from the aforementioned loop leading to an unpressurized water line connecting an array of water probes which sense nutrient solution chemistry, such as acidity and total dissolved solids.
1. 6. A high pressure aeroponics system in accordance with claim 1, further comprising a pressure release valve for draining the system.
1. 7. A high pressure aeroponics system in accordance with claim 1, further comprising means of cooling, heating, and exchanging the air in the root container; especially by means of the climate conditioning apparatus described in claim 2.

2. A bidirectional temperature and humidity control system which can draw air from one or more input selectable sources, perform temperature and humidity adjustments on the passing air flow, and direct that air flow to one or more selectable locations, comprising:
2. 1. Barriers for air containment which creates three general divided sections of air which connect to the inputs and outputs of the temperature and humidity control system as described in claim 2: the shoot enclosure, the root enclosure, and the ambient air.
2. 2. The apparatus of claim 2 comprising a method of selecting one or more sources to draw air from, and utilizing a fan to draw that air in from the selected source(s) and generate air flow in the system.
2. 3. The temperature and humidity control system as described in claim 2, further comprising an apparatus for sensing temperature and humidity levels of said passing air flow and transmitting those values to the microcontroller.
2. 4. The apparatus of claim 2, comprising means of cooling said passing air flow.
2. 5. The apparatus of claim 2, comprising means of dehumidifying said passing air flow and collecting condensation.
2. 6. The apparatus of claim 2, comprising means of heating said passing air flow.
2. 7. The apparatus of claim 2, comprising means of humidifying said passing air flow.
2. 8. The temperature and humidity control system as described in claim 2, further comprising an apparatus for selectively directing the air flow to one or more locations.
